(19) United States
(12) Patent Application Publication
(10) Pub. No.: US 2025/0190801 A1
(43) Pub. Date: Jun. 12, 2025

(54) PROMPT SUITABILITY ANALYSIS FOR LANGUAGE MODEL-BASED AI SYSTEMS AND APPLICATIONS

(71) Applicant: NVIDIA Corporation, Santa Clara, CA (US)

(72) Inventor: Joseph Tran Lucas, Santa Clara, CA (US)

(21) Appl. No.: 18/532,048

(22) Filed: Dec. 7, 2023

(51) Int. Cl. G06N 3/0895

(52) U.S. Cl. CPC G06N 3/0895

(57) ABSTRACT

Disclosed are apparatuses, systems, and techniques that evaluate suitability of prompts for language model (LM) processing for improved quality and security of LM outputs. The techniques include determining prompt verification score(s) that include a first subset of tokens and a second subset of tokens, and obtaining, using an LM, the individual prompt verification score characterizing a likelihood that the second subset of tokens occurs, in the prompt, together with the first subset of tokens. The techniques further include determining, using the prompt verification score(s), whether the prompt is to be provided to the LM.

### TECHNICAL FIELD

At least one embodiment pertains to computing resources used to perform and/or facilitate natural language technologies. For example, at least one embodiment pertains to systems and techniques that facilitate and improve quality of processing of user questions and queries by language models.

### BACKGROUND

Well-trained language models—such as large language models (LLMs)—are capable of supporting conversations in natural language, understanding speaker's intent and emotions, explaining complex topics, generating new texts upon receiving suitable prompts, writing and debugging software codes, providing advice regarding topics of interest to a user, processing image, audio, and/or other data types, and/or performing other functions. LLMs typically undergo self-supervised training on massive amounts of text data and/or other data types, depending on the implementation, and learn to predict next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, LLMs often undergo instructional (prompt-based) supervised fine-tuning that causes LLMs to acquire more in-depth language proficiency and/or master more specialized tasks. Supervised fine-tuning includes using learning prompts (questions, hints, etc.) that are accompanied by example texts (e.g., answers, sample essays, etc.) serving as training ground truth. In reinforcement fine-tuning, a human evaluator assigns grades indicative of a degree to which the generated text resembles human-produced texts.

### BRIEF DESCRIPTION OF DRAWINGS

FIG. 1 is a block diagram of an example computer system capable of implementing suitability analysis of user prompts in the context of language model (LM) processing for improved quality and security of LM outputs, according to at least one embodiment;

FIG. 2 illustrates an example computing device 200 that supports live suitability analysis of prompts prior to LM processing, according to at least one embodiment;

FIG. 3 illustrates an architecture of an example prompt analyzer deployed for improving quality and security of LM outputs, according to at least one embodiment;

FIG. 4 illustrates an architecture of an example system that uses prompt analysis to select one of multiple LMs for prompt processing, according to at least one embodiment;

FIG. 5 illustrates a data flow of example operations of a LM with prompt analysis processing, according to at least one embodiment;

FIG. 6 is a flow diagram of an example method of performing a suitability analysis of prompts prior to LM processing for improved quality and security of LM outputs, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment.

### DETAILED DESCRIPTION

LLM capabilities are, at least in part, determined by the amount and diversity of training data used to train the LLM. Yet even LLMs trained on massive amounts of data can suffer from hallucinations (invocation of irrelevant or random information), factual inaccuracies, and/or other similar instances that diminish user experiences and reliability of LLM outputs. Such instances occur because of a practically unlimited number of topics that can be subjects of user prompts (questions, queries, instructions, etc.) and/or ways in which user prompts can be formulated, with the range of topics/formulations invariably exceeding the breadth of training data, however massive. In such instances, tasking an LLM to respond to a user prompt is unlikely to result in a quality response (answer) that would be helpful to the user. Evaluation of LLM responses for reasonableness and factual accuracy (often termed “model alignment”), however, is a very challenging task. Automating such a task may require training one or more arbiter models (e.g., models trained in specific subject matter of the prompts) to at least the same level of sophistication as the LLM that is being monitored. This significantly increases the cost and duration of training of the models.

Furthermore, some of the prompts can come as part of a malicious prompt injection attack during which an attacker attempts to manipulate an LLM to produce a desired (e.g., offensive, misleading, fraudulent, etc.) output. For example, during a user-chatbot conversation, an attacker can try to intercept and supplement user prompts with additional information and/or instructions that hijack the chatbot's personality and cause the chatbot to respond in an inappropriate manner. In yet other instances, an LLM can receive a prompt asking for specific knowledge that the LLM lacks (e.g., “what are side effects of Zidovudine?”), a prompt asking for help in manufacturing an illegal device or substance, and/or any other request that is against the public policy or a scope of a user agreement with the LLM services. As is the case with LLM hallucinations, detection of such instances based on analysis of LLM outputs can be a daunting and expensive process.

Aspects and embodiments of the present disclosure address these and other technological challenges by providing for systems and techniques that analyze suitability of user prompts for LLM processing before such processing is attempted. Prompt analysis alleviates the need to evaluate quality and accuracy of the actual LLM outputs by leveraging the LLM's own training to determine the limits of the LLM's proficiency. In particular, a prompt analyzer can evaluate a sequence of prompt tokens (numerical representations of words of the prompt) {Tⱼ}=T₁, T₂, . . . T_{N} to obtain a statistical distribution and an evaluation metric M characterizing a likelihood that the sequence of tokens {Tⱼ} is of a type encountered in LLM training, as opposed to an unseen type of prompt, a prompt requiring specialized knowledge, a prompt that is likely to be used by a malicious attacker, a request for information that is against the LLM service policy, and/or the like. The prompt analyzer can use the LLM's learned ability to determine a probable next token to follow a sequence of known tokens. In some embodiments, the LLM may be used to determine a likelihood of a missing token Tₘ in a sequence of given tokens, T₁, . . . , Tₘ₋₁, Tₘ₊₁ . . . Tⱼ instead of (or in addition to) the likelihood of the next token(s).

More specifically, the prompt analyzer can form a verification prompt that includes n first tokens of the user prompt, T₁, T₂, . . . Tⱼ, where j can be 1, 2, . . . N−1, depending on a specific iteration of prompt verification. The verification prompt T₁, T₂, . . . Tⱼ can then be used as an input into the LLM that determines the probability Pⱼ that the next word of the prompt, Tⱼ₊₁, is to follow the first j tokens of the prompt. After a sequence of N−1 such probabilities P₁, P₂ . . . P_{N-1} has been obtained, the evaluation metric M may be calculated, e.g., using the product, M=Πⱼ₌₁^{N-1}Pⱼ (which may also be normalized by the number of tokens in the prompt to account for prompts of varying length, e.g., M=NΠⱼ₌₁^{N-1}). The evaluation metric M estimates the likelihood that the user prompt is of a type represented in the corpus of training data that was used in LLM training.

A low metric M indicates that at least some token transitions Tⱼ→Tⱼ₊₁ in the user prompt correspond to unusual word combinations that the LLM did not learn in training (or did not learn with sufficient reliability). Provided that the metric M is below a threshold metric, M_{T} (which may be set empirically based on field testing), the prompt analyzer may determine that the LLM is not capable of generating an accurate and reliable response to the user prompt or that the prompt is of a type that should not be processed by the LLM. In such instances, the prompt may be returned to the user with an explanation that the LLM cannot process the prompt, a suggestion that the prompt be rephrased, and/or the like. In the instances where M≥M_{T}, the prompt analyzer may determine that the LLM is likely to generate an acceptable, reliable, and accurate response and may pass the user prompt to LLM for regular processing.

In some embodiments, where multiple LLMs (e.g., specialized-knowledge models) are available, the prompt analyzer may perform multiple prompt verifications (e.g., in parallel) for the multiple models and then select the model with the highest metric M indicative of the best familiarity of the corresponding model with the subject matter of the user prompt. In some embodiments, rather than selecting from multiple LLMs, the system may select from various prompt tuning models that are trained to adapt the prompt to a specific domain the prompt tuning model is configured for. As such, where the LLM itself may not have a high M score, the LLM in combination with a specific prompt tuning model may have an acceptable M score that may make the combination suitable for addressing the query or particular task at hand.

The advantages of the disclosed techniques include but are not limited to identification of unsuitable or malicious prompts, prompts that exceed the model's learned abilities, and/or the like, without the need for specialized arbiter models (or human arbiters). This ensures quality and security of language model processing while maintaining a high speed of such processing. Front end prompt verification decreases the number of confusing, misleading, and/or factually incorrect language model responses, improves user satisfaction, and reduces instances of misuse of language models.

### System Architecture

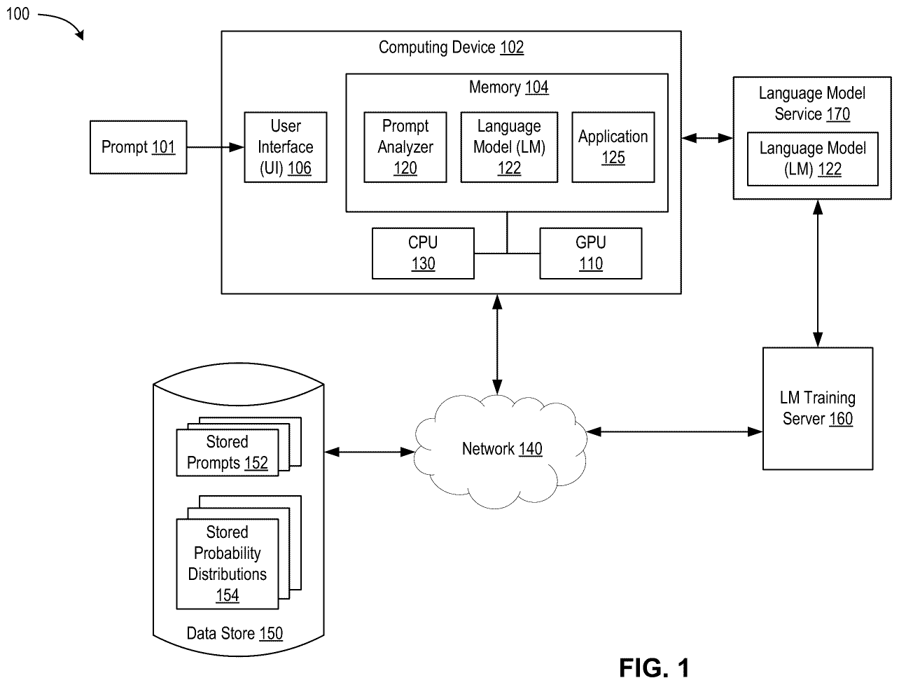

FIG. 1 is a block diagram of an example computer system 100 capable of implementing suitability analysis of user prompts in the context of language model (LM) processing for improved quality and security of LM outputs, according to at least one embodiment. As depicted in FIG. 1, computer system 100 may include a computing device 102, a data store 150, and a LM training server 160 connected to a network 140. Network 140 may be a public network (e.g., the Internet), a private network (e.g., a local area network (LAN), or wide area network (WAN)), a wireless network, a personal area network (PAN), a combination thereof, and/or another network type.

Computing device 102 may include a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any suitable computing device capable of performing the techniques described herein. Computing device 102 may be configured to receive a prompt 101 that may be any human-generated or machine-generated data capable of being used, directly or after a suitable preprocessing, as an input into an LM 122. In some embodiments, LM 122 may be an LLM, e.g., a model with hundreds of millions or one or more billion of learned parameters. Prompt 101 may include a text (e.g., a sequence of one or more typed words), a speech (e.g., a sequence of one or more spoken words), an image (e.g., a drawing or a picture), a video or series of images, a tokenized sequence of sensor data, and/or any combination thereof. Prompt 101 may be generated as part of interaction of any user (including a computing program or any other machine user) with any entity that deploys, uses, and/or interfaces to LM 122. Such an entity may include a chatbot, a digital avatar, a digital assistant, an in-vehicle communication system, a gaming application, and/or any other digital agent capable of using a natural language prompt. The interaction may include a private conversation, a customer-agent session, a browsing session, an information-gathering session, a research inquiry, a multi-speaker conversation, a public conversation, a work session, and/or any combination thereof. Prompt 101 may be formulated as a statement, a query, a question, a request for explanation/tutorial, a request for advice, an expression of emotion, a narrative (or a portion of a narrative), and/or any other type of input that calls for a response from LM 122, and/or the like. In some embodiments, prompt 101 may include text and/or speech generated by a computer, e.g., any language model that is different from LM 122.

Prompt 101 may be received via any suitable user interface (UI) 106, which may include one or more devices of various modalities. For example, prompt 101 may be received via a keyboard, a touchscreen, a touchpad, a writing pad, a graphical interface, a mouse, a stylus, and/or using any other pointing device capable of selecting words/phrases that are displayed on a screen, and/or some other suitable device. In some embodiments, UI 106 may include an audio device, e.g., a microphone, a video device, such as a digital camera to capture a video prompt, a sequence of two or more images (video frames). In some embodiments, text, speech, and/or video input devices may be integrated together (e.g., into a smartphone, tablet computer, desktop computer, and/or the like).

Prompt 101 may be captured live (e.g., typed, recorded, etc.) using one or more peripheral devices connected to computing device 102 (e.g., keyboard, microphone, digital camera), retrieved from memory 104 of computing device 102, and/or received over any local or network connection (e.g., via network 140) from an external computing device. Text prompt(s) 101 may be in any suitable text format, e.g., plain text format, a document format (DOC), a Rich Text Format (RTF), a Hypertext Markup Language (HTML) format, an Extensible Markup Language (XML) format, a Portable Document Format (PDF), and/or the like. Speech prompt(s) 101 may be in any suitable audio format, e.g., WAV, AIFF, MP3, AAC, WMA, or any other compressed or uncompressed audio format. Likewise, video prompt(s) 101 may be in any suitable video format, e.g., raw video data format, MPEG-4 format, MOV format, WMV format, AVI format, or any other compressed or uncompressed video format.

Computing device 102 may include a memory 104 (e.g., one or more memory devices or units) communicatively coupled to one or more processing devices, such as one or more graphics processing units (GPU) 110, one or more central processing units (CPU) 130, one or more data processing units (DPU), one or more parallel processing units (PPUs), and/or other processing devices (e.g., field-programmable gate arrays (FPGAs), application-specific integrated circuits (ASICs), and/or the like). Memory 104 may include a read-only memory (ROM), a flash memory, a dynamic random-access memory (DRAM), such as synchronous DRAM (SDRAM), a static memory, such as static random-access memory (SRAM), and/or some other memory capable of storing digital data. Memory 104 may store a prompt analyzer 120, LM 122, and an application 125. Application 125 may include any software that leverages capabilities of LM 122 to provision natural language services to users. For example, application 125 may include a chatbot application, a browser application, a digital avatar application, a digital assistant application, a chatbot application, and/or the like. Prompt analyzer 120 may implement various techniques of the instant disclosure. For example, prompt analyzer 120 may parse prompt 101 into individual words or tokens and construct one or more verification prompts that include some of the words/tokens of prompt 101 while excluding some other words/tokens of prompt 101 Prompt analyzer 120 may feed the constructed verification prompts to LM 122 and receive, from LM 122 various probabilities (verification scores) indicating likelihoods that one or more words/tokens not included in verification prompts can occur together with words/tokens of verification prompts as part of the same prompt 101. Based on the received probabilities, prompt analyzer 120 may determine if prompt 101 is a valid prompt or invalid prompt. A valid prompt is a prompt of a type that LM 122 is trained to process and whose processing is not against some relevant (public and/or private) policy. An invalid prompt is a prompt that LM 122 has not been adequately trained to process (e.g., a prompt requiring specialized knowledge not learned by LM 122), a prompt whose content violates some relevant policy, a prompt that is likely to generate a response that would violate any relevant policy, an unusual prompt, a prompt that may have been generated by a malicious attacker, and/or the like. Prompt 101 determined to be valid may be forwarded to LM 122 for regular processing. Prompt 101 determined to be invalid may be returned to a (human or machine) user that generated prompt 101 with a suggestion to rephrase prompt 101 or a notification that prompt 101 cannot be processed.

In some embodiments, LM 122 may be a model that is trained and deployed by an external (relative to computing device 102) entity, e.g., language model service 170, which may be a cloud service, a subscription service, and/or some combination thereof. In some embodiments, LM 122 may be trained by LM training server 160. In some embodiments, LM 122 (and/or other deployed language models) may be or include a large language model (LLM). LM 122 may be trained to capture syntax and semantics of human language, e.g., by predicting a next, a previous, and/or a missing word in a sequence of words (e.g., one or more sentences of a human speech or text). LM 122 may be further trained using training data containing a large number of texts, such as human dialogues, newspaper texts, magazine texts, book texts, web-based texts, and/or any other texts. Since ground truth for such training is embedded in the texts themselves, LM training server 160 may use such texts for self-supervised training of LM 122. This teaches LM 122 how to carry out a conversation with a user (a human user or a computer) in a natural language in a manner that closely resembles a dialogue with a human speaker, including understanding the user's intent and responding in ways that the user expects from a conversational partner.

Following the initial self-supervised training, LM training server 160 may implement instructional (e.g., prompt-based) training of LM 122, e.g., supervised fine-tuning that causes LM 122 to acquire an in-depth language proficiency and/or master more specialized tasks. Supervised fine-tuning may include learning prompts (questions, hints, etc.) that are accompanied by example texts (e.g., answers, sample essays, etc.) used as the training ground truth. In some embodiments, LM training server 160 may further implement reinforcement training where a human evaluator assigns grades indicating a degree to which the generated text resembles a human-produced text.

In some embodiments, LM training server 160 may train multiple LMs 122, which may be models that differ by a number of neurons, number of neuron layers, specific neural architecture, and/or the like. Various trained LMs 122 may be trained (e.g., fine-tuned) using specialized texts, e.g., medical texts, mathematical texts, scientific texts, computer technology texts, and/or the like.

LM 122 may be implemented using neural networks with a large number (e.g., billions) of artificial neurons. In at least one embodiment, LM 122, and/or other deployed models, may be implemented as deep learning neural networks having multiple levels of linear and non-linear operations. For example, LM 122 may include convolutional neural networks, recurrent neural networks, fully-connected neural networks, long short-term memory (LSTM) neural networks, neural networks with attention, e.g., transformer neural networks, a combination of a convolutional network and one or more transformers (a conformer), and/or neural networks of other types. In at least one embodiment, LM 122 may include multiple neurons, with an individual neuron receiving its input from other neurons and/or from an external source and producing an output by applying an activation function to the sum of weighted (using trainable weights) inputs and, possibly, a bias value. In at least one embodiment, LM 122 may include multiple neurons arranged in layers, including an input layer, one or more hidden layers, and/or an output layer. Neurons from adjacent layers may be connected by weighted edges.

Initially, parameters (e.g., edge weights and biases) of LM(s) 122 may be assigned some starting (e.g., random) values. For various training inputs, LM training server 160 may cause LM(s) 122 to generate training output(s). LM training server 160 may then compare training output(s) with the desired target output(s). The resulting error or mismatch, e.g., the difference between the target output(s) and the training output(s), may be backpropagated through various neural layers of LM(s) 122, and the weights and biases of LM(s) 122 may be adjusted to make the training outputs closer to the target (ground truth) outputs. This adjustment may be repeated until the output error for a given training input satisfies a predetermined condition (e.g., falls below a predetermined value). Subsequently, a different training input may be selected, a new training output generated, and a new series of adjustments implemented, until LM(s) 122 is trained to a target degree of accuracy or until LM(s) 122 converges to a limit of its accuracy.

In some embodiments, operations of prompt analyzer 120 may generate additional training data that can be used for retraining of LM 122 (or multiple LMs 122). For example, prompts 101 that are determined to be invalid by prompt analyzer 120 may be stored in data store 150. Additionally, various probability distributions (e.g., next-token probabilities computed for various prompts 101) may also be stored in data store 150. Stored prompts 152 and/or stored probability distributions 154 may then be used by LM training server 160 to retrain LM 122. For example, stored prompts 152 may be used to identify (e.g., using keyword search of stored prompts 152) subject areas in which LM 122 is lacking expertise and identify an additional corpus of texts and/or other data for retraining of LM 122. Likewise, stored probability distributions 154 may be used to identify next-word transitions (e.g., transitions between tokens T₁ . . . Tⱼ and token Tⱼ₊₁) in stored prompts 152 that were determined to be low-probability transitions (causing prompt analyzer 120 to classify the corresponding stored prompts 152 as invalid). LM training server 160 may then identify texts (e.g., using a suitable search engine crawler) that include such and/or similar transitions and retrain LM 122 using these identified texts.

Data store 150 may be accessed by LM training server 160 and/or computing device 102 directly (e.g., via a bus, interconnect, and/or the like) or (as shown in FIG. 1) via network 140. Data store 150 may include a persistent storage capable of storing audio files as well as metadata for the stored audio files. Data store 150 may be hosted by one or more storage devices, such as main memory, magnetic or optical storage disks, tapes, or hard drives, network-attached storage (NAS), storage area network (SAN), and so forth. Although depicted as separate from LM training server 160 and/or computing device 102, in at least some embodiments, data store 150 may be a part of LM training server 160 and/or computing device 102. In at least some embodiments, data store 150 may be a network-attached file server, while in other embodiments data store 150 may be some other type of persistent storage, such as an object-oriented database, a relational database, and so forth, that may be hosted by LM training server 160 and/or computing device 102 or one or more different machines coupled to LM training server 160 and/or computing device 102 via network 140.

In at least one embodiment, LM training server 160 and computing device 102 may be implemented on a single computing device. LM training server 160 and/or computing device 102 may be (and/or include) a rackmount server, a router computer, a personal computer, a laptop computer, a tablet computer, a desktop computer, a media center, or any combination thereof.

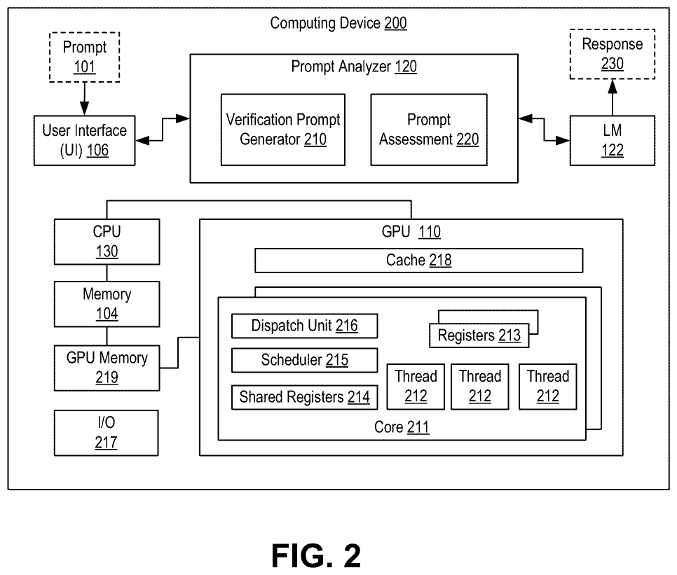

FIG. 2 illustrates an example computing device 200 that supports live suitability analysis of prompts prior to LM processing, according to at least one embodiment. In at least one embodiment, computing device 200 may be a part of computing device 102. In at least one embodiment, computing device 200 may be a part of LM training server 160. In at least one embodiment, computing device 200 supports prompt analyzer 120 that includes (but need not be limited to) a verification prompt generator 210, prompt assessment 220, and language model 122. Prompt analyzer 120 may be capable of processing prompt 101 and generating a response 230. Response 230 may be a text response, a speech (voice) response, e.g., a text response that is additionally converted into speech via a text-to-speech processing, and/or the like.

Operations of prompt analyzer 120 and/or one or more LMs 122 may be executed using one or more GPUs 110, one or more CPUs 130, one or more parallel processing units (PPUs) or accelerators, such as a deep learning accelerator, data processing units (DPUs), and/or the like. In at least one embodiment, a GPU 110 includes multiple cores 211, each core being capable of executing multiple threads 212. Each core may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of the core. In at least one embodiment, each core 211 may include a scheduler 215 to distribute computational tasks and processes among different threads 212 of core 211. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 110 may have a (high-speed) cache 218, access to which may be shared by multiple cores 211. Furthermore, computing device 200 may include a GPU memory 219 where GPU 110 may store intermediate and/or final results (outputs) of various computations performed by GPU 110. After completion of a particular task, GPU 110 (or CPU 130) may move the output to (main) memory 104. In at least one embodiment, CPU 130 may execute processes that involve serial computational tasks whereas GPU 110 may execute tasks (such as multiplication of inputs of a neural node by weights and adding biases) that are amenable to parallel processing. In at least one embodiment, prompt analyzer 120 and/or LMs 122 may determine which processes are to be executed on GPU 110 and which processes are to be executed on CPU 130. In other embodiments, CPU 130 may determine which processes are to be executed on GPU 110 and which processes are to be executed on CPU 130.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing generative AI operations, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems implemented at least partially using cloud computing resources, and/or other types of systems.

### Systems and Techniques for Prompt Analysis

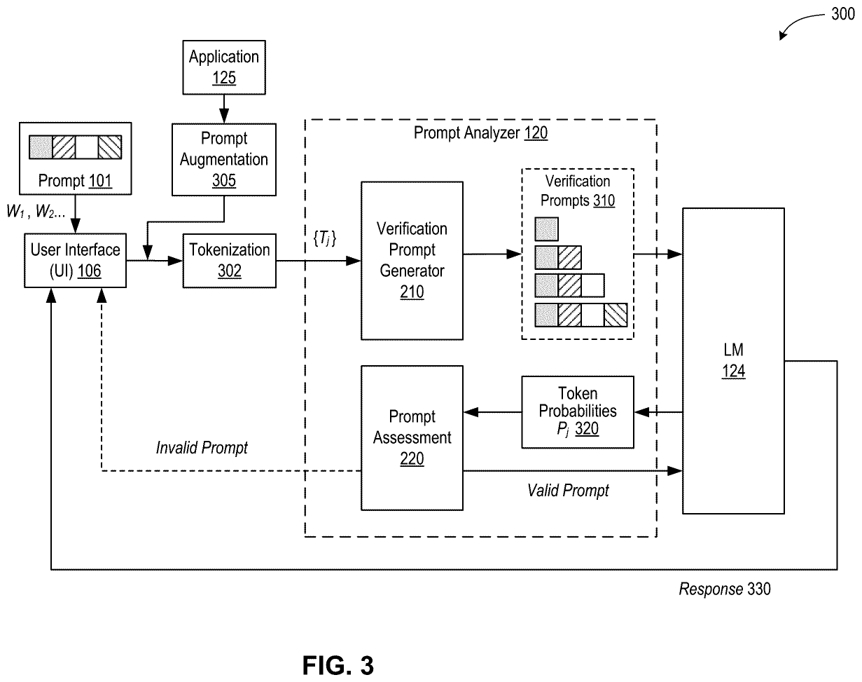

FIG. 3 illustrates an architecture 300 of an example prompt analyzer deployed for improving quality and security of LM outputs, according to at least one embodiment. In at least one embodiment, prompt analyzer illustrated in FIG. 3 may be prompt analyzer 120 of FIG. 1 and FIG. 2. Various blocks denoted in FIG. 3 with the same numerals as the respective blocks of FIG. 1 and/or FIG. 2 may implement the same (or a similar) functionality. Various blocks of FIG. 3 may correspond to modules and components located on a single computing device or distributed across multiple computing devices. For example, LM 124 may be implemented on the same server (e.g., computing device 102 of FIG. 1) as prompt analyzer 120 or on a different server (e.g., one or more computing devices of language model service 170 of FIG. 1). Prompt 101 may be received using UI 106, e.g., as described in conjunction with FIG. 1.

Prompt augmentation 305 may augment prompt 101 with any suitable information provided by application 125. For example, prompt augmentation 305 may include personality assigned to LM 124 by application 125, various contextual information related to prompt 101, identification of type (e.g., subject matter) of prompts 101 that LM 124 is to answer or do not answer, definitions of response formats, and/or the like.

Prompt 101 may undergo tokenization 302 to represent a sequence of words W₁, W₂ . . . of prompt 101 via a sequence of tokens recognizable by LM 124. A set of tokens that are understood by LM 124 may be LM-specific (different for different models and model creators) and fixed during training of LM 124. The set of tokens may include any suitable representation of units of speech (e.g., syllables, words, etc.) as numbers. In one example of GPT-4 tokens, word “the” may be represented via token “280”, word “import” may be represented via token “476,” word “description” may be represented via token “4097,” and so on. In some embodiments, individual words may be represented using any number of tokens or word transitions. For example, a long word or a word that contains multiple words may be represented via multiple tokens, e.g., with one token used to represent a beginning portion of the word and another token(s) representing a middle or end portion of the word. In some instances, even a long/composite word may be represented by a single token. As such, tokenizing 302 may be performed in any manner that is suitable for input to LM 124.

In some embodiments, a suitable preprocessing (not shown in FIG. 1) may be performed prior to tokenization 302. For example, in the instance of speech prompts 101, the preprocessing may include audio filtering, denoising, amplification, dereverberation, segmentation, audio signal enhancement, and speech-to-text processing to identify the sequence of spoken words W₁, W₂ . . . in prompt 101. Speech-to-text processing may be performed using any trained automatic speech recognition (ASR) model and may further include removal of portions of the audio recording that correspond to filler words/sounds or do not have a speech content (pauses, noises, etc.).

Tokenization 302 transforms the sequence of words into a sequence of tokens W₁, W₂, . . . →{Tⱼ}=T₁, T₂, . . . T_{N}. The number of tokens N may be different from (e.g., be larger or smaller) than the number of written or spoken words in prompt 101. Instead of providing the received sequence of tokens {Tⱼ} directly to LM 124, as would be the case in conventional systems, tokens {Tⱼ} may first be provided to prompt analyzer 120. Prompt analyzer 120 may use a verification prompt generator 210 to generate one or more verification prompts 310 that are built from some of the tokens {Tⱼ} and provided to LM 124 with instructions to predict tokens that are not included in verification prompts 310.

In one example embodiment, N−1 verification prompts 310 may be generated. The first verification prompt may include a first token T₁, a second token T₂, and an instruction to LM 124 to predict conditional probability P(T₂|T₁) that the second token T₂ follows the first token T₁. Similarly, the second verification prompt may include a first token T₁, a second token T₂, a third token T₂, and an instruction to LM 124 to predict conditional probability P(T₃|T₁, T₂) that the third token T₃ follows the sequence of the first token T₁ and the second token T₂. The jth verification prompt may include a sequence of tokens T₁, T₂, . . . Tⱼ together with the next token Tⱼ₊₁ and an instruction to LM 124 to predict conditional probability P(Tⱼ₊₁|T₁, T₂, . . . Tⱼ) that j+1th token Tⱼ₊₁ follows the sequence of tokens T₁, T₂, . . . Tⱼ.

In generating and receiving responses to verification prompts 310, prompt analyzer 120 leverages the learned ability of LM 124 to determine a likely next token that follows a sequence of given tokens. LM 124 may be trained to process an input string of tokens and generate probabilities (e.g., using a softmax classifier) for various tokens of the token corpus (vocabulary) of LM 124 (which may include thousands of tokens). Prompt analyzer 120 may then obtain, from LM 124, the conditional probability 320 for the target token Tⱼ₊₁ to be the next token, Pⱼ≡P(Tⱼ₊₁|T₁, T₂, . . . Tⱼ) for the target token Tⱼ₊₁. For example, prompt analyzer 120 may access a neuron in the output (softmax) layer of LM 124 that outputs next-token probability for target token Tⱼ₊₁. After various generated verification prompts 310 have been processed, and a set of N−1 such token probabilities {Pⱼ}=P₁, P₂ . . . P_{N-1} has been received, prompt assessment 220 may evaluate the received probabilities to determine a viability of prompt 101. More specifically, prompts 101 that correspond to the proficiency domain of LM 124 may be characterized by the set of probabilities {Pⱼ} that have relatively uniform values, e.g., without a significant drop in one or more probabilities indicative of unexpected transitions between tokens (words). Such unexpected transitions may signal a malicious attack or a lack of LM's learned abilities. A suitable response to such unexpected prompts 101 may be to decline processing of the prompts.

In some embodiments, decision-making regarding prompt 101 processing may be performed by computing a suitable evaluation metric M representative of the set of probabilities {Pⱼ}. In one embodiment, the evaluation metric may be computed as the product (which may be normalized to the number of probabilities (e.g., N−1, or N), to account for prompts 101 of variable lengths,

$$M = N {\prod }_{j = 1}^{N - 1} {P}_{j} .$$

Presence of unexpected token-to-token transitions is captured by the evaluation metric M since one or more anomalously small probabilities make the whole evaluation metric M low.

In some embodiments, the evaluation metric M may be defined by a minimum probability of the distribution of probabilities,

$$M = min ( {P}_{1} , {P}_{2} , … , {P}_{N - 1} ) .$$

In other embodiments, the evaluation metric M may be computed using any other function of the probabilities {Pⱼ}, e.g., an arithmetic average, a harmonic average, an average or product of a predetermined number of the lowest probabilities Pⱼ, and/or the like.

In some embodiments, verification prompts 310 may ask LM 124 to predict probabilities of multiple (two or more) tokens, e.g., tokens Tⱼ₊₁ and Tⱼ₊₂ after a set of given tokens T₁, T₂, . . . Tⱼ.

In the above autoregressive prompt generation scheme, LM 124 is tasked with computing a probability of the next token Tⱼ₊₁ that follows a set of given tokens T₁, T₂, . . . Tⱼ. In some embodiments, a fill-mask prompt generation scheme may be used instead of, or in addition to, the autoregressive schedule. More specifically, verification prompt generator 210 may instruct LM 124 to predict a probability of a missing token Tₘ in a sequence of given tokens, T₁, . . . , Tₘ₋₁, Tₘ₊₁ . . . Tⱼ. The corresponding probability may be obtained from a corresponding (to missing token Tₘ) neuron of the output layer of LM 122.

In some embodiments, the evaluation metric M may be generated by a trained prompt evaluation machine learning model (MLM) deployed as part of prompt assessment 220. More specifically, an input into the prompt evaluation MLM may include a distribution of token probabilities {Pⱼ} and an output M may characterize a degree of suitability of LM 124 to process the prompt,

$$\{ {P}_{j} \} \to MLM \to M .$$

During training of the prompt evaluation MLM, a training prompt may be selected, e.g., generated by a developer or obtained from a public database of user-asked queries. A set of verification prompts 310 may then be generated as disclosed above and used to obtain a distribution of token probabilities {Pⱼ} from LM 124. The training prompt may also be processed by LM 124 and a human developer may assign a metric M to a response generated by LM 124, e.g., based on factual accuracy, subject-matter suitability, compliance with various public and/or private policies, and/or the like. The distribution of token probabilities {Pⱼ} may then be used as the training input into the prompt evaluation MLM and the metric M may be used as the ground truth for training of the prompt evaluation MLM.

Prompt assessment 220 may compare the evaluation metric M to a threshold metric M_{T}. The threshold metric M_{T} may be determined empirically, e.g., as part of testing of prompt analyzer 120. Based on a result of the comparison, prompt assessment 220 may determine whether prompt 101 is valid, e.g., if M≥M_{T} (or M>M_{T}), or invalid, e.g., if M<M_{T} (or M≤M_{T}). A low metric M indicates that LM 124 is not capable of generating an accurate and reliable response to prompt 101 or that the prompt is not to be processed by the LM 124 (e.g., for policy reasons). In such instances, prompt assessment 220 may determine prompt 101 to be invalid prompt and return prompt 101 to UI 106, e.g., together with a suggestion to rephrase the prompt, an explanation that the prompt cannot be processed in the current from, and/or the like. A high metric M indicates that LM 124 is likely to generate an acceptable response. In such instances, prompt assessment 220 may determine prompt 101 to be valid and provide prompt 101 to LM 124. Having processed prompt 101, LM 124 may return a generated response 330 to a user via UI 106.

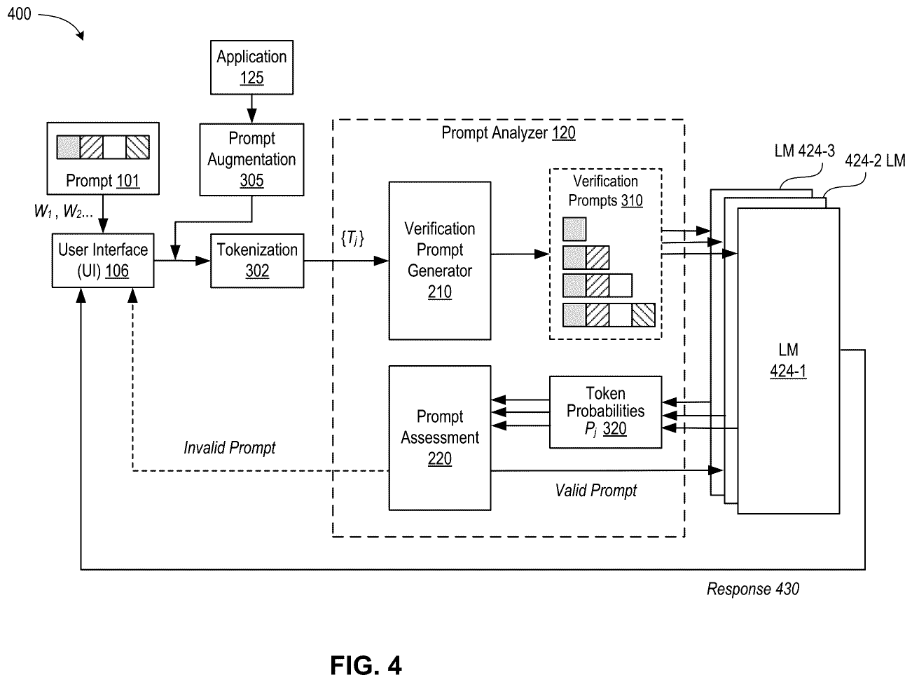

FIG. 4 illustrates an architecture 400 of an example system that uses prompt analysis to select one of multiple LMs for prompt processing, according to at least one embodiment. Various blocks of FIG. 4 denoted with the same numerals as the respective blocks of FIG. 3 may implement the same (or a similar) functionality. As illustrated in FIG. 4, verification prompts 310 generated by verification prompt generator 210 may be provided (e.g., in parallel) to multiple trained LMs, e.g., LM 424-1, LM 424-2, LM 424-3, and/or the like (three LMs are depicted in FIG. 4 for illustration, but any other number of LMs may be deployed). Different LMs 424-k may be models trained using different specialized data, e.g., LM 424-1 may be a model trained with medical data, LM 424-2 may be a model trained using financial information, LM 424-3 may be a model trained using math texts, and/or the like. Individual LMs 424-k may return separate distributions of token probabilities that may be used by prompt assessment 220 to generate separate evaluation metrics Mk for separate LMs. Prompt assessment 220 may then select a model with the highest evaluation metric and, further conditional on the highest evaluation metric being above (or at) the threshold metric M_{T}, identify prompt 101 as a valid prompt and provide prompt 101 to that model (which is expected to be the optimal model for handling the prompt). FIG. 4 illustrates a situation where prompt 101 is provided to LM 424-2. After processing prompt 101 and generating a response 430, the model (e.g., LM 424-2) may deliver response 430 to a user via UI 106. If no evaluation metric Mk is at or above the threshold metric M_{T}, prompt 101 may be determined to be invalid and returned to the user via UI 106, e.g., as described in conjunction with FIG. 3.

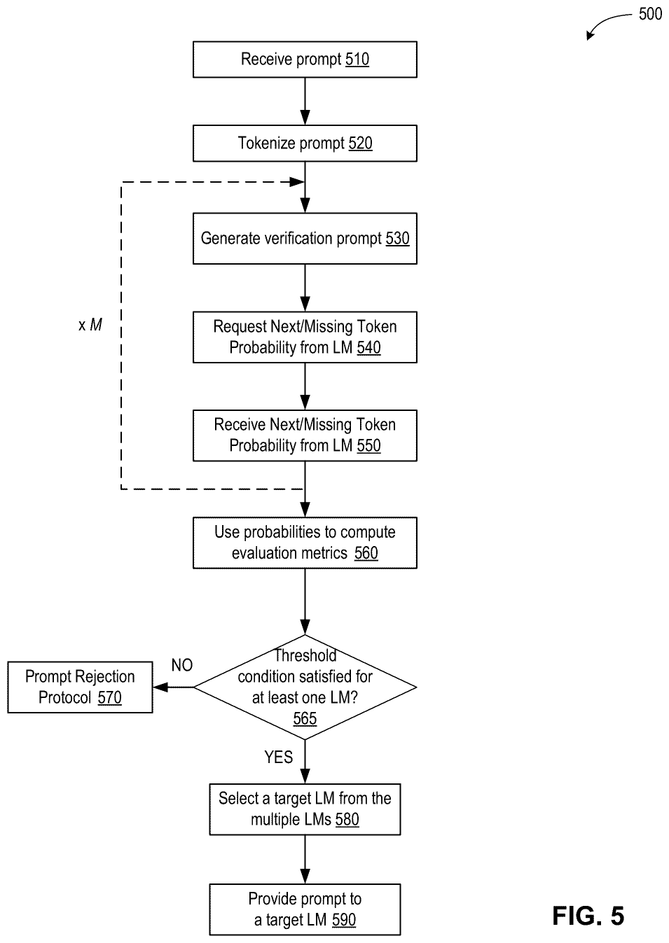

FIG. 5 illustrates a data flow of example operations 500 of a LM with prompt analysis processing, according to at least one embodiment. At block 510, operations 500 may include receiving a prompt, e.g., from a human or machine user. The prompt may be in a natural language. At block 520, the prompt may be tokenized, by representing words of the prompt via tokens of a set of natural language tokens used by an LM. At block 530, a prompt analyzer may generate a verification prompt and provide, at block 540, the verification prompt to LM asking for a probability of the next or missing token from LM. At block 550, the prompt analyzer may receive the requested probability. Operation of blocks 530-550 may be repeated multiple times to obtain a distribution of such probabilities for the prompt. At block 560, the probabilities of next/missing token may be used to compute one or more evaluation metrics for the prompt. The evaluation metrics may be computed for one or more LMs available for prompt processing. At decision-making block 565, the prompt analyzer may determine whether the evaluation metric is satisfied for at least one of the available LMs, e.g., by comparing the computed evaluation metrics to a threshold metric. If no evaluation metric meets or exceeds the threshold metric, operations 500 may proceed to block 570 implementing a suitable prompt rejection protocol consistent with policies of the language model services. For example, the protocol may include a notification to the user that the prompt cannot be processed, a suggestion to the user to rephrase the prompt, and/or the like. If at least one evaluation metric meets or exceeds the threshold metric, the prompt analyzer may, at block 580, select a target LM for processing of the prompt. For example, the LM with the highest evaluation metric may be selected as the target LM. At block 590, the prompt may be provided to the target LM. After the LM has processed the prompt and generated a response, the response may be provided to the user.

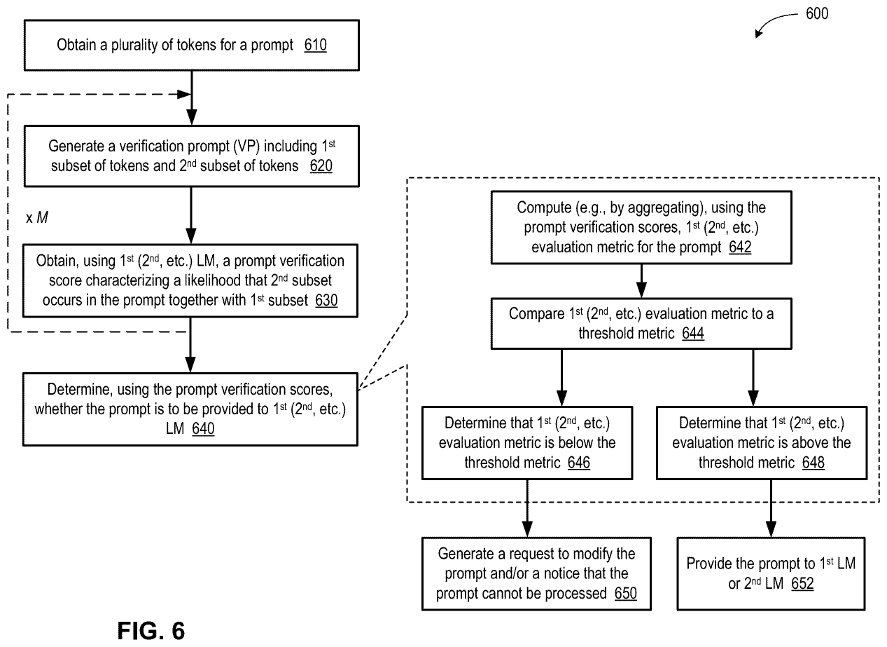

FIG. 6 is a flow diagram of an example method 600 of performing a suitability analysis of prompts prior to LM processing for improved quality and security of LM outputs, according to at least one embodiment. Method 600 may be performed using one or more processing units (e.g., CPUs, GPUs, accelerators, PPUs, DPUs, etc.), which may include (or communicate with) one or more memory devices. In at least one embodiment, method 600 may be performed using processing units of computing device 102 of FIG. 1 and/or computing device 200 of FIG. 2. In at least one embodiment, processing units performing method 600 may be executing instructions stored on a non-transient computer-readable storage media. In at least one embodiment, method 600 may be performed using multiple processing threads (e.g., CPU threads and/or GPU threads), with individual threads executing one or more individual functions, routines, subroutines, or operations of the methods. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not always be performed.

Method 600 may involve prompts produced by entering (e.g., typing) the text of a prompt, uttering the words of the prompt, e.g., as part of any question, request, conversation, dialogue, and/or any other suitable interaction of a human user with an AI system, in one example embodiment.

At block 610, method 600 may include obtaining a plurality of tokens associated with a prompt (e.g., by processing prompt 101 using tokenizer 302 of FIG. 3). The prompt may include a text (e.g., any digital representation of letters, syllables, words, phrases, sentences, and/or the like), a speech (e.g., any digital audio representation of uttered words), a video (e.g., a sequence of video frames), or some other plurality of images (e.g., related by context rather than representing a temporal video sequence).

At blocks 620-630, method 600 may include determining one or more prompt verification scores for evaluating suitability of the prompt for LM processing. More specifically, at block 620, method 600 may generate a verification prompt. The verification prompt may include a first subset of the plurality of tokens and a second subset of the plurality of tokens. The first subset may include one or more tokens that are to be provided to LM as unconditional (known) tokens. The second subset may include one or more tokens that are to be provided to LM as conditional tokens whose occurrence or non-occurrence together with the first subset may be probabilistic. In some embodiments, the second subset of tokens may include a token that follows the first subset of tokens or a token that occurs inside the first subset of tokens. In some embodiments, the second subset may include a next token (e.g., token Tⱼ₊₁) that follows the first subset of tokens (e.g., tokens T₁ . . . Tⱼ) and excludes a token that follows the next token (e.g., excludes token Tⱼ₊₂).

At block 630, method 600 includes obtaining, using a first LM, an individual prompt verification score (e.g., Pⱼ) that characterizes a likelihood that the second subset of one or more tokens occurs, in the prompt, together with the first subset of tokens (e.g., that token Tⱼ₊₁ follows tokens T₁ . . . Tⱼ).

In some embodiments, operations of blocks 620 and 630 may be performed over multiple iterations (e.g., N−1 iterations, or some other number of iterations). In one illustrative example, a pair of back-to-back iterations may be performed as follows, each iteration—first or second—including a respective (first or second) verification prompt. The terms “first” and/or “second” should be understood as mere identifiers and do not mean that the first verification prompt is chronologically the earliest verification prompt being generated and/or processed. Specifically, the first subset of tokens of a first verification prompt may include first k tokens (e.g., T₁ . . . Tₖ) of the plurality of tokens, with k being an integer number that is less than N−1, wherein N is the total number of tokens in the prompt. The second subset of the first verification prompt may include the k+1th token (e.g., token Tₖ+1) of the prompt (but may also include other tokens). Similarly, the first subset of the second verification prompt may include the first k+1 tokens (e.g., T₁ . . . Tₖ₊₁) of the prompt, and the second subset of tokens of the second verification prompt may include the k+2th token (e.g., Tₖ₊₂) of the prompt (but may also include other tokens).

In some embodiments, operations of blocks 620-630 may also be performed for additional LMs (e.g., a second, third, etc.), e.g., to determine one or more additional prompt verification scores. Determining an individual additional prompt verification score of the one or more additional prompt verification scores may include obtaining, using a second (third, etc.) LM, the individual prompt verification score characterizing a likelihood that the second subset of one or more tokens occurs, in the prompt, together with the first subset of tokens. In such embodiments, e.g., as described below in conjunction with blocks 648 and 652, the one or more additional prompt verification scores may be used for determining whether the prompt is to be provided to the first (second, etc.) LM.

At block 640, method 600 may continue with determining, using the one or more prompt verification scores (and, in some embodiments, the additional prompt verification scores), whether the prompt is to be provided to the first LM. In some embodiments, operations of block 640 may include operations indicated with the callout portion of FIG. 6. More specifically, at block 642, method 600 may include computing, using the one or more prompt verification scores (e.g., P₁ . . . P_{N-1}), an evaluation metric (e.g., M) for the prompt. In some embodiments, computing the evaluation metric for the prompt may include aggregating (e.g., computing a product, a sum, and/or some other suitable functions) the one or more prompt verification scores to obtain the evaluation metric. In some embodiments, method 600 may include computing, using the one or more prompt verification scores, a first evaluation metric (e.g., M₁) for the prompt (characterizing suitability of the prompt for the first LM), and may further include computing, using the one or more additional prompt verification scores, a second (thirds, etc.) evaluation metric (e.g., M₂, M₃, etc.) for the prompt (characterizing suitability of the prompt for the second LM, third LM, etc.). At block 644, method 600 may continue with comparing the computed evaluation metric to a threshold metric. In some embodiments, multiple evaluation metrics (computed for multiple LMs) may be compared to the threshold metric.

In some instances, as indicated with block 646, to determine whether the prompt is to be provided to the first LM, the processing units performing method 600 may determine that the evaluation metric (e.g., M) is below the threshold metric (e.g., M_{T}) (or that each evaluation metric computed for individual available LMs is less than M_{T}). At block 650, method 600 may continue with generating a response (e.g., to the user that produced the prompt) that includes a request to modify the prompt or a notice that the prompt cannot be processed.

In other instances, as indicated with block 648, to determine whether the prompt is to be provided to the first LM, the processing units performing method 600 may determine that the evaluation metric is above the threshold metric (e.g., that M₁>M_{T}). In such instances, method 600 may continue with providing the prompt to the first LM. In some embodiments, when two or more LMs are available for processing the prompt, method 600 may include providing the prompt to the first LM, responsive to the first evaluation metric being above the second evaluation metric (M₁>M₂). In those instances where the first evaluation metric is below the second evaluation metric (M₁<M₂), method 600 may include providing the prompt to the second LM.

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Inference and Training Logic

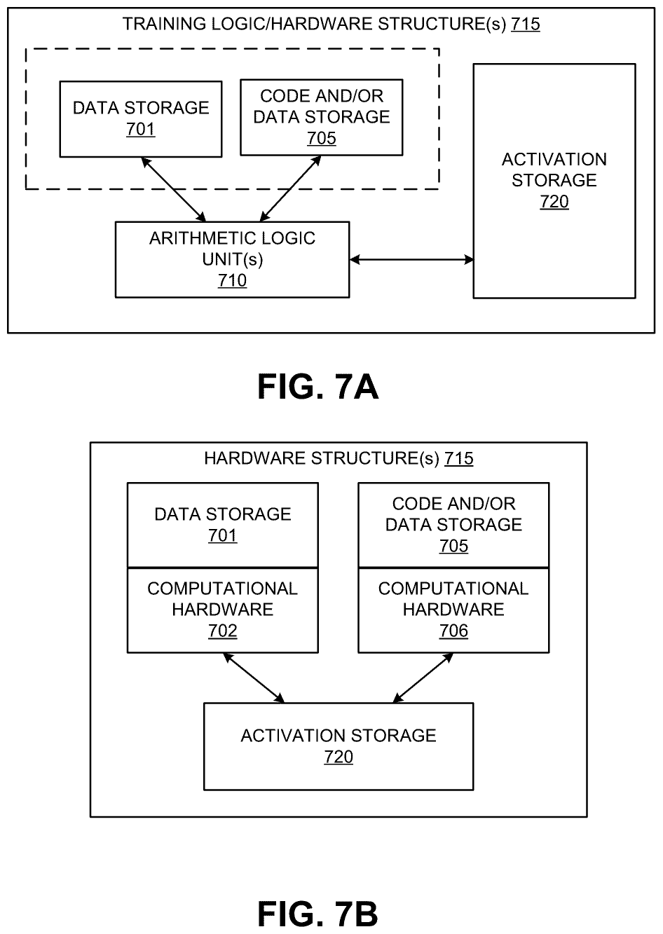

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

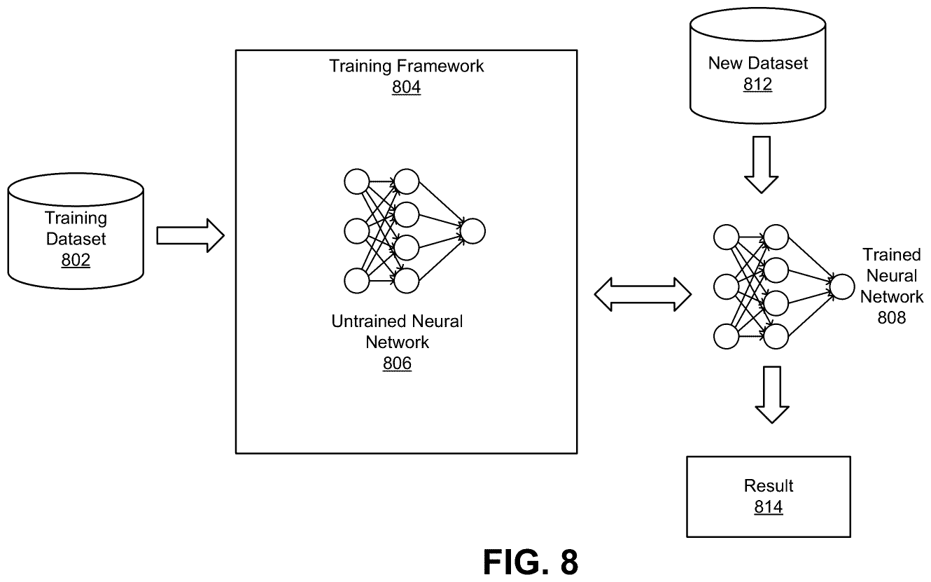

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

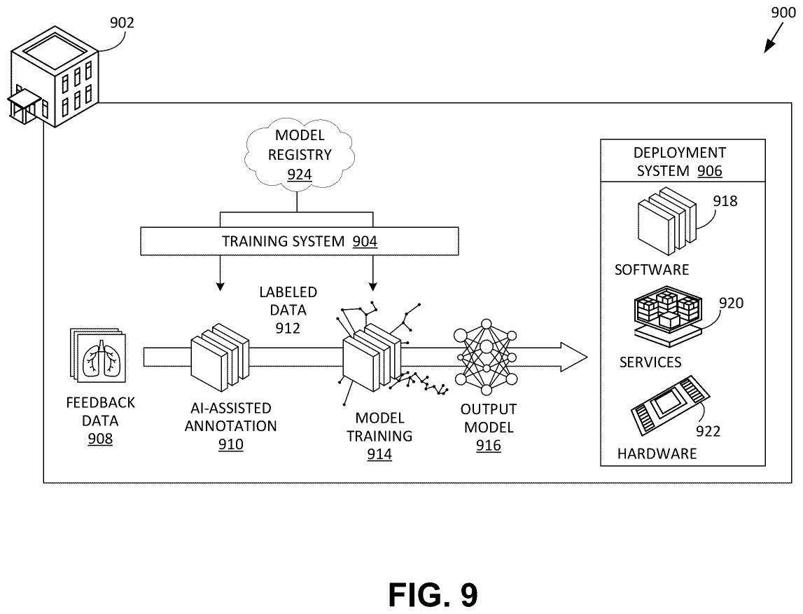

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

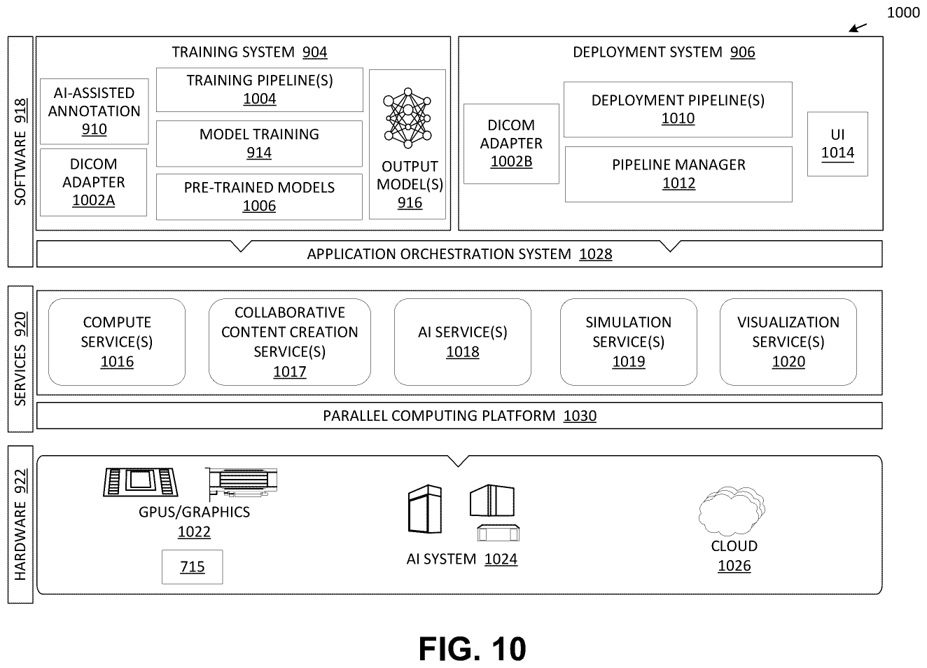

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
obtaining a plurality of tokens associated with a prompt;
determining one or more prompt verification scores by, at least, for an individual prompt verification score of the one or more prompt verification scores:
generating a verification prompt comprising:
a first subset of one or more tokens of the plurality of tokens, and
a second subset of one or more tokens of the plurality of tokens; and
obtaining, using a language model (LM), the individual prompt verification score characterizing a likelihood that the second subset of one or more tokens occurs, in the prompt, together with the first subset of one or more tokens; and
determining, using the one or more prompt verification scores, whether to provide the prompt to the LM.

2. The method of claim 1, wherein the prompt comprises at least one of a text, a speech, a video, or a plurality of images.

3. The method of claim 1, wherein the second subset of one or more tokens comprises at least one of:
a token that follows the first subset of one or more tokens, or
a token that occurs inside the first subset of one or more tokens.

4. The method of claim 1, wherein the second subset of one or more tokens comprises a next token that follows the first subset of one or more tokens and excludes a token that follows the next token.

5. The method of claim 1, wherein:
the first subset of one or more tokens of a first verification prompt comprises first k tokens of the plurality of tokens, wherein k is an integer number that is less than N−1, wherein N is a number of the plurality of tokens,
the second subset of one or more tokens of the first verification prompt comprises k+1th token of the plurality of tokens,
the first subset of one or more tokens of a second verification prompt comprises first k+1 tokens of the plurality of tokens, and
the second subset of one or more tokens of the second verification prompt comprises k+2th token of the plurality of tokens.

6. The method of claim 1, wherein the determining whether to provide the prompt to the LM comprises:
computing, using the one or more prompt verification scores, an evaluation metric for the prompt; and
comparing the evaluation metric to a threshold metric.

7. The method of claim 6, wherein computing the evaluation metric for the prompt comprises:
aggregating the one or more prompt verification scores to obtain the evaluation metric.

8. The method of claim 6, wherein the determining whether to provide the prompt to the LM further comprises:
determining that the evaluation metric is above the threshold metric; and
providing the prompt to the LM.

9. The method of claim 6, wherein the determining whether to provide the prompt to the LM further comprises:
determining that the evaluation metric is below the threshold metric; and
wherein the method further comprises:
generating a response comprising at least one of:
a request to modify the prompt, or
a notice that the prompt cannot be processed.

10. The method of claim 1, further comprising:
determining one or more additional prompt verification scores, wherein determining an individual additional prompt verification score of the one or more additional prompt verification scores comprises:
obtaining, using a second LM, the individual prompt verification score characterizing a likelihood that the second subset of one or more tokens occurs, in the prompt, together with the first subset of one or more tokens; and
wherein determining whether the prompt is to be provided to the LM comprises:
using the one or more additional prompt verification scores.

11. The method of claim 10, wherein the determining whether to provide the prompt to the LM further comprises:
computing, using the one or more prompt verification scores, a first evaluation metric for the prompt; and
computing, using the one or more additional prompt verification scores, a second evaluation metric for the prompt.

12. The method of claim 11, further comprising performing at least one of:
providing, responsive to the first evaluation metric being above the second evaluation metric, the prompt to the LM, or
providing, responsive to the first evaluation metric being below the second evaluation metric, the prompt to the second LM.

13. A system comprising:
one or more processing units to:
obtain a plurality of tokens associated with a prompt;
determine at least one prompt verification score by, at least:
generating a verification prompt comprising a first subset of one or more tokens of the plurality of tokens and a second subset of one or more tokens of the plurality of tokens; and
obtaining, using a language model (LM), the at least one prompt verification score characterizing a likelihood that the second subset of one or more tokens occurs, in the prompt, together with the first subset of one or more tokens; and
determine, using the at least one prompt verification score, whether to provide the prompt to the LM or whether to present an output generated using the prompt.

14. The system of claim 13, wherein the second subset of one or more tokens comprises at least one of:
a token that follows the first subset of one or more tokens, or
a token that occurs inside the first subset of one or more tokens.

15. The system of claim 13, wherein to determine whether to provide the prompt to the LM or whether to present the output generated using the prompt, the one or more processing units are to:
compute, using the at least one prompt verification score, an evaluation metric for the prompt; and
compare the evaluation metric to a threshold metric.

16. The system of claim 15, wherein to determine whether to provide the prompt to the LM or whether to present the output generated using the prompt, the one or more processing units are further to perform at least one of:
provide, responsive to determining that the evaluation metric is above the threshold metric, the prompt to the LM, or
generate, responsive to determining that the evaluation metric is below the threshold metric, a response comprising at least one of (i) a request to modify the prompt, or (ii) a notice that the prompt cannot be processed.

17. The system of claim 13, wherein the one or more processing units are further to:
determine one or more additional prompt verification scores, wherein to determine an individual additional prompt verification score of the one or more additional prompt verification scores, the one or more processing units are to:
obtain, using a second LM, the individual prompt verification score characterizing a likelihood that the second subset of one or more tokens occurs, in the prompt, together with the first subset of one or more tokens; and
wherein to determine whether to provide the prompt to the LM or whether to present the output generated using the prompt, the one or more processing units are to:
use the one or more additional prompt verification scores.

18. The system of claim 17, wherein to determine whether to provide the prompt to the LM or whether to present the output generated using the prompt, the one or more processing units are further to:
compute, using the one or more prompt verification scores, a first evaluation metric for the prompt; and
compute, using the one or more additional prompt verification scores, a second evaluation metric for the prompt; and
wherein the one or more processing units are further to perform at least one of:
provide, responsive to the first evaluation metric being above the second evaluation metric, the prompt to the LM, or
provide, responsive to the first evaluation metric being below the second evaluation metric, the prompt to the second LM.

19. The system of claim 13, wherein the system is comprised in at least one of:
an in-vehicle infotainment system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

20. One or more processors to:
determine at least one prompt verification score by, at least:
generating a verification prompt comprising a first subset of one or more tokens of the plurality of tokens and a second subset of one or more tokens of the plurality of tokens; and
obtaining, using a language model (LM), the at least one verification score characterizing a likelihood that the second subset of one or more tokens occurs, in the prompt, together with the first subset of one or more tokens; and
determine, using the at least one prompt verification score, whether to provide the prompt to the LM or whether to present an output generated based at least on the prompt.
